(19) United States
(12) Patent Application Publication
(10) Pub. No.: US 2017/0283623 A1
(43) Pub. Date: Oct. 5, 2017

(54) Two-Stage Corrosion Barrier Between Two Work Pieces

(71) Applicant: Dana Automotive Systems Group, LLC, Maumee, OH (US)

(72) Inventors: Collin M. McCabe, Fayette, OH (US); Thomas M. O'Neil, Holland, OH (US); Stephen JE Springer, Monroe, MI (US)

(21) Appl. No.: 15/478,859

(22) Filed: Apr. 4, 2017

Related U.S. Application Data
(60) Provisional application No. 62/318,947, filed on Apr. 6, 2016.
(60) Provisional application No. 62/318,197, filed on Apr. 4, 2016.

(51) Int. Cl. C09D 5/08; B23K 20/06; B65B 53/02; F16C 3/02

(52) U.S. Cl. CPC C09D 5/08; F16C 3/023; B23K 20/06; B65B 53/02; B05D 2259/00

(57) ABSTRACT

A method and assembly for preventing corrosion between two work pieces. At least a portion of a neck portion of a second end portion of an end piece is disposed within a hollow portion in a first end portion of a drive shaft tube. The inner surface of the first end portion of the drive shaft tube is magnetic pulse welded to a first tapered portion of the neck portion of the end piece. A coating and a sacrificial material is applied over an interface between an end surface of said first end portion of said drive shaft and said end piece defining a gap. The coating and sacrificial material is then leveled and a shrink-wrap material is disposed radially outboard from the gap. Finally, heat is applied to the shrink-wrap material sealing said gap.

### CROSS-REFERENCE TO RELATED APPLICATIONS

The present application claims the benefit to U.S. Provisional patent Application No. 62/318,197 filed on Apr. 4, 2016 and U.S. Provisional patent Application No. 62/318,947 filed on April 6, which are incorporated herein by reference in their entirety.

### FIELD OF THE INVENTION

The present disclosure relates to a method of preventing corrosion between work pieces made of dissimilar materials.

### BACKGROUND OF THE DISCLOSURE

Magnetic pulse welding is a commonly used method of joining two work pieces together. Drive shaft assemblies, having a drive shaft tube and an end piece, can incorporate the use of the magnetic pulse welding process to join the tube of the drive shaft to the end piece. U.S. RE 41,101 to Yablochnikov provides background on the use of the magnetic pulse welding process in the assembly of a drive shaft. U.S. RE 41,101 is hereby incorporated by reference herein in its entirety to the extent permitted by law.

In brief, a hollow drive shaft tube having an opening at an end of the hollow drive shaft tube extends co-axially with a neck portion of an end piece. At least a portion of the neck portion of the end piece is disposed within the opening in the end of the hollow drive shaft tube. Before the magnetic pulse welding process begins, an annular gap exists between the drive shaft tube and the end piece. An electrical inductor is disposed concentrically about or within the coaxially overlapping portions of the drive shaft tube and the end piece. When the inductor is energized, the inductor generates a magnetic field that either drives the end of the drive shaft tube inward into engagement with the neck portion of the end piece or it expands the neck portion of the end piece into engagement with the end of the drive shaft tube. In either event, the high velocity impact of the two work pieces, in combination with the relatively large amount of pressure exerted thereon, causes the end of the drive shaft tube to be permanently joined to the end piece.

When one of the adjacent surfaces of the end of the drive shaft tube or the neck portion of the end piece is tapered, the energization of the inductor causes the two work pieces to collide into one another in an axially progressive manner from one end of the tapered surface to the other. This type of a slanting collision is one of the physical conditions necessary to achieve a strong, high-quality weld when using magnetic pulse welding to join two work pieces together.

After the magnetic pulse welding process is completed, a gap will remain at the interface between an end surface of the drive shaft tube and a shoulder portion of the end fitting. The gap between the end surface of the drive shaft tube and the shoulder portion of the end fitting may undesirably retain dirt, debris and/or moisture within the gap if not sealed. In particular, the accumulation of moisture within the gap can be problematic as it can corrode one or both of the materials making up the drive shaft tube and the end piece. If the moisture accumulated within the gap is composed of salt water, such as that found on a salted roadway, the salt water can act as an electrolyte between the materials of the two work pieces. This is particularly problematic when the two work pieces are of dissimilar materials as the electrolytic solution may cause galvanic corrosion to begin and the corrosion will continue if left untreated. Any corrosion at the gap initially results in a degraded appearance. If the corrosion is not dealt with, it can compromise the weld between the drive shaft tube and the end piece reducing the overall life and durability of the drive shaft assembly.

Conventional methods of addressing this issue incorporate the use of a sealant that is painted over the area of the joint. For example, U.S. Pat. No. 6,389,697 (“the '697 patent”) recognizes that the magnetic pulse welding process can be used to join aluminum and steel materials together and that the interface of these materials needs to be protected from corrosion due to a galvanic reaction. Additionally, the patent '697 indicates that “[t]hese concerns are easily addressed using conventional painting or sealing techniques in the joint areas.” U.S. Pat. No. 6,908,024 and U.S. Patent Application Publication No. 2005/0035586, which both deal with magnetic pulse welding of dissimilar materials, indicate that a corrosion inhibitor can be added to welded surfaces. Lastly, U.S. Patent Publication No. 2012/0071250 (“the '250 application) discloses the use of a spacer between an end fitting and a drive shaft. The '250 application indicates that a ultra-violet (UV) cured urethane coating can be sprayed onto the spacer and subsequently cured with UV light. The above-mentioned references only deal with joints in vehicle frame members while the present disclosure is particularly suited for a joining work pieces that are subjected to torsional or twisting forces. It would therefore be advantageous to develop a method of preventing corrosion between two work pieces made of different materials that is able to withstand the torsional or twisting forces exerted on the joint between the rotating work pieces.

### SUMMARY OF THE DISCLOSURE

The present disclosure relates to a method and apparatus for preventing corrosion between two work pieces. The first work piece is a drive shaft tube having a first end portion having an inner surface and an outer surface defining a hollow portion therein.

Extending co-axially with the drive shaft tube is an end piece having a first end portion and a second end portion. The first end portion of the end piece includes a first axially extending yoke arm and a second axially extending yoke arm. At least a portion of the second end portion of the end piece has a neck portion having a first tapered portion and a second tapered portion. When assembled, at least a portion of the neck portion of the end piece is disposed within the hollow portion in the first end portion of the drive shaft tube.

Once assembled, the inner surface of the first end portion of the drive shaft tube is welded to the first tapered portion of the neck portion of the end piece. As a non-limiting example, the inner surface of the first end portion of the drive shaft tube is welded to the first tapered portion of the end piece by using a magnetic pulse welding process.

After the end piece is welded to the drive shaft tube a coating material and a sacrificial material is applied to an interface between an end surface of said first end portion of said drive shaft and said end piece defining a gap. The coating and sacrificial material is then leveled and a shrink-wrap material is disposed radially outboard from the gap. Finally, heat is applied to the shrink-wrap material sealing said gap.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is an exploded schematic perspective view of a drive shaft end piece assembly according to an embodiment of the disclosure;

FIG. 2 is a schematic side-view of a portion of the drive shaft end piece assembly illustrated in FIG. 1 with at least a portion of the end piece disposed within the drive shaft prior to welding the components together;

FIG. 3 is a schematic side-view of a portion of the drive shaft end piece assembly illustrated in FIGS. 1-2 with at least a portion of the end piece disposed within the drive shaft after the components have been welded together;

FIG. 4 is a schematic perspective-view of the drive shaft end piece assembly illustrated in FIGS. 1-3 after the drive shaft tube and the end piece have been welded together and a gap between the two components is cleaned with a wire brush;

FIG. 5 is a schematic perspective-view of the drive shaft end piece assembly illustrated in FIGS. 1-4 after the drive shaft tube and the end piece have been welded together, the gap between the two components is cleaned and a coating is applied over the gap;

FIG. 6 is a schematic perspective-view of the drive shaft end piece assembly illustrated in FIGS. 1-5 after the coating is applied over the gap and the coating material is leveled using a squeegee;

FIG. 7 is a schematic perspective-view of the drive shaft end piece assembly illustrated in FIGS. 1-6 after the coating material has been leveled and a shrink wrap material is placed around the gap between the two components of the drive shaft end piece assembly;

FIG. 8 is a schematic perspective-view of the drive shaft end piece assembly illustrated in FIGS. 1-6 after the shrink wrap material has been shrunk and sealed around the gap between the two components of the drive shaft end piece assembly; and

FIG. 9 is a flow chart illustrating the method of sealing the gap between the end piece and the drive shaft tube according to an embodiment of the disclosure.

### DETAILED DESCRIPTION OF THE DISCLOSURE

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

It is within the scope of this disclosure, and as a non-limiting example, that the method of preventing corrosion between work pieces made of dissimilar materials disclosed herein may be used in automotive, off-road vehicle, all-terrain vehicle, construction, structural, marine, aerospace, locomotive, military, machinery, robotic and/or consumer product applications. Additionally, as a non-limiting example, the method of preventing corrosion between work pieces made of dissimilar materials disclosed herein may also be used in passenger vehicle, electric vehicle, hybrid vehicle, commercial vehicle, autonomous vehicles, semi-autonomous vehicles and/or heavy vehicle applications.

Described herein is a method for preventing corrosion between two work pieces. When two work pieces are joined together using a magnetic pulse welding process, a gap may result at the welding interface. If through the gap the weld between the work pieces is exposed to certain environmental conditions, such as salt water, the salt water in the gap of the work pieces can cause them to undesirably corrode. A method and apparatus are needed to prevent the corrosion.

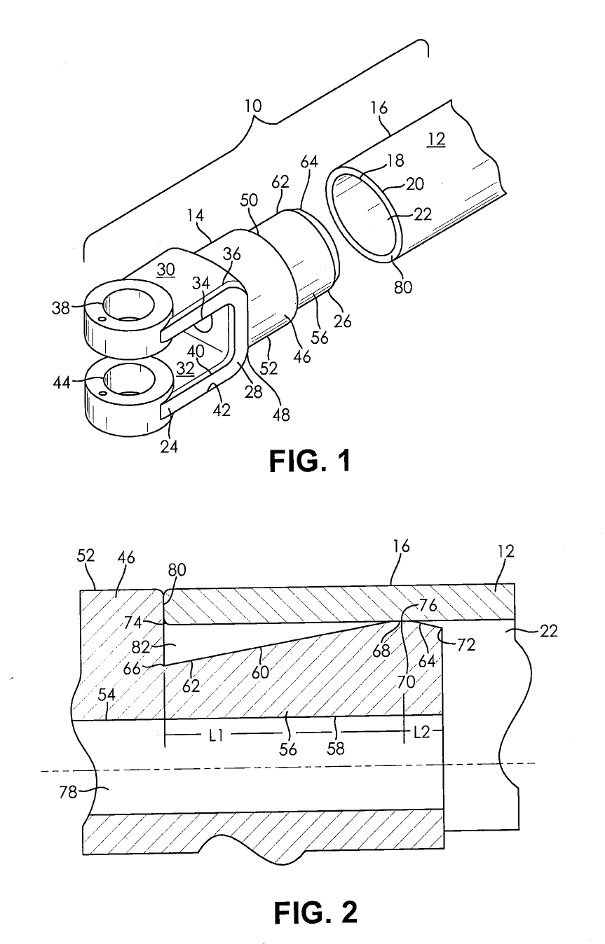

FIGS. 1-8 are a schematic view of a drive shaft end piece assembly 10 according to an embodiment of the disclosure. As illustrated in FIG. 1 of the disclosure, the drive shaft and end piece assembly 10 includes a drive shaft tube 12 and an end piece 14. The drive shaft tube 12 includes a first end portion 16 having an inner surface 18 and an outer surface 20 defining a hollow portion 22 therein. According to an embodiment of the disclosure and as a non-limiting example, the drive shaft tube 12 is substantially cylindrical in shape having a substantially uniform wall thickness. In accordance with an embodiment of the disclosure and as a non-limiting example, the drive shaft tube 12 is a propeller shaft, a drive shaft, a cardan shaft, a double cardan shaft, a universal joint shaft, a universal coupling shaft or a Hooke's joint shaft. As a non-limiting example, the drive shaft tube 12 may be made of an iron alloy, a steel alloy, an aluminium alloy, a titanium allow or any other material that is able to withstand the tension, compression, radial, axial and/or torsional loads that are exerted onto the drive shaft tube 12.

Extending co-axially with the drive shaft tube 12 is the end piece 14. As illustrated in FIG. 1, the end piece 14 has a first end portion 24, a second end portion 26 and an intermediate portion 28 disposed between the first and second end portions 24 and 26. According to an embodiment of the disclosure and as a non-limiting example, the end piece 14 is a component of a universal joint, a U-joint, a universal coupling, a cardan joint, a double cardan joint, a Hooke's joint, a Spicer joint, a homokinetic coupling, a constant velocity joint, a Hardy Spicer joint or a companion flange. In accordance with the embodiment of the disclosure illustrated in FIG. 1 and as a non-limiting example, the end piece 14 is a metallic end yoke. As a non-limiting example, the end piece 14 may be made of an iron alloy, a steel alloy, an aluminium alloy, a titanium allow or any other material that is able to withstand the tension, compression, radial, axial and/or torsional loads that are exerted onto the end piece 14.

According to the embodiment of the disclosure illustrated in FIG. 1 of the disclosure, the first end portion 24 of the end piece 14 has a pair of ears or yoke arms 30 and 32. As illustrated in FIG. 1, the yoke arms 30 and 32 extend axially outboard from at least a portion of the intermediate portion 28 of the end piece 14. The first axially extending yoke arm 30 on the first end portion 24 of the end piece 14 has an inner surface 34 and an outer surface 36. Extending from the inner surface 34 to the outer surface 36 of the first axially extending yoke arm 30 is an opening 38. The opening 38 in the first axially extending yoke arm 30 is of a size and a shape to receive at least a portion of a bearing cap (not shown) that is attached to an outer surface of a trunnion (not shown) of a journal cross (not shown).

The second axially extending yoke arm 32 on the first end portion 24 of the end piece 14 has an inner surface 40 and an outer surface 42. Extending from the inner surface 40 to the outer surface 42 of the second axially extending yoke arm 32 of the end piece 14 is an opening 44. The opening 44 in the second axially extending yoke arm 32 is aligned with the opening 38 in the first axially extending yoke arm 30 of the end piece 14. The opening in the second axially extending yoke arm 32 is of a size and a shape to receive at least a portion of a bearing cap (not shown) that is attached to an outer surface of a trunnion (not shown) of a journal cross (not shown).

Extending axially outboard from the intermediate portion 28 of the end piece 14, away from the pair of axially extending yoke arms 30 and 32, is a body portion 46 having a first end 48, a second end 50, an inner surface 52 and an outer surface 54. In accordance with the embodiment of the disclosure illustrated in FIG. 1, the first end 48 of the body portion 46 of the end piece 14 is adjacent to the pair of axially extending yoke arms 30 and 32 extending from the intermediate portion 28 of the end piece 14. As illustrated in FIG. 1 and as a non-limiting example, the body portion 46 of the end piece 14 is substantially cylindrical in shape.

A neck portion 56 having an inner surface 58 and an outer surface 60 extends axially outboard from the second end 50 of the body portion 46 of the end piece 14. As illustrated in FIGS. 1-3 of the disclosure, the outer surface 60 of the neck portion 56 of the end piece 14 has a first tapered portion 62 and a second tapered portion 64. According to an embodiment of the disclosure and as a non-limiting example, the first tapered portion 62 of the neck portion 56 of the end piece 14 has a length L1 that is longer than a length L2 of the second tapered portion 64 of the neck portion 56 of the end piece 14. The first tapered portion 62 of the neck portion 56 of the end piece 14 has a first end 66 and a second end 68. Additionally, the second tapered portion 64 of the neck portion 56 of the end piece 14 has a first end 70 and a second end 72.

The first end 66 of the first tapered portion 62 of the neck portion 56 of the end piece 14 has an outer diameter that is smaller than an outer diameter of the body portion 46 of the end piece 14. An annular shoulder portion 74 connects the second end 50 of the body portion 46 of the end piece 14 to the first end 66 of the first tapered portion 62 of the neck portion 56 of the end piece 14. In accordance with an embodiment of the disclosure and as a non-limiting example, the annular shoulder portion 74 of the end piece 14 extends substantially vertically from the first end 66 of the first tapered portion 62 to the second end 50 of the body portion 46 of the end piece 14.

In accordance with the embodiment of the disclosure illustrated in FIGS. 1-3, the outer diameter of the outer surface 60 of the first tapered portion 62 increases from the first end 66 to the second end 68 of the first tapered portion 62 of the neck portion 56 of the end piece 14. Additionally, the outer surface 60 of the second tapered portion 64 has an outer diameter that decreases from the first end 70 to the second end 72 of the second tapered portion 64 of the neck portion 56 of the end piece 14. As illustrated in FIGS. 1-3 of the disclosure, the second end 68 of the first tapered portion 62 connects to the first end portion 70 of the second tapered portion 64 defining an outermost diameter 76 of the neck portion 56 of the end piece 14. As a non-limiting example, the outer diameter 76 of the neck portion 56 of the end piece 14 is smaller than the outer diameter of the body portion 46 of the end piece 14.

According to the embodiment of the disclosure illustrated in FIGS. 1-3, the inner surfaces 54 and 58 of the body portion 46 and the neck portion 56 define a hollow portion 78 therein. It is within the scope of this disclosure that the end piece 14 may exclude the use of the hollow portion 78 in the body portion 46 and the neck portion 56 of the end piece 14.

When the drive shaft and end piece assembly 10 is assembled, at least a portion of the neck portion 56 of the end piece is disposed within the hollow portion 22 of the first end portion 16 of the drive shaft tube 12. As a non-limiting example, when assembled, the neck portion 56 of the end piece 14 is inserted within the hollow portion 22 of the drive shaft tube 12 until at least a portion of an end surface 80 of the drive shaft tube 12 is in direct contact with at least a portion of the annular shoulder portion 74 of the end piece 14. When the drive shaft tube 12 is assembled over the neck portion 56 of the end piece 14, an annular gap 82 exists between the inner surface 18 of the first end portion 16 of the drive shaft tube 12 and the outer surface 60 of the first tapered portion 62 of the end piece 14. The overall size and shape of the annular gap 82 varies in dimension with the shape of the outer surface 60 of the first tapered portion 62 of the neck portion 56 of the end piece 14. According to an embodiment of the disclosure and as a non-limiting example, the annular gap 82 has a radial dimension of up to approximately five millimeters. In accordance with an embodiment of the disclosure and as a non-limiting example, the overall shape of the annular gap 82 is substantially uniform.

The second tapered portion 64 of the neck portion 56 of the end piece 14 aids in the installation of the neck portion 56 of the end piece 14 within the hollow portion 22 of the first end portion 16 of the drive shaft tube 12. As a result, the second tapered portion 64 of the end piece 14 reduces the amount of time needed to assemble the end piece 14 within the hollow portion 22 of the drive shaft tube 12 thereby decreasing the overall cost associated with assembling the drive shaft and end piece assembly 10.

The outermost diameter 76 of the neck portion 56 of the end piece 14 may be slightly smaller than, approximately equal to or slightly larger than an inner diameter of the inner surface 18 of the first end portion 16 of the drive shaft tube 12. When the outermost diameter 76 of the neck portion 56 is approximately equal to or slightly larger than the inner diameter of the first end portion 16 of the drive shaft tune 12, the end piece 14 is positively retained within the hollow portion 22 of the drive shaft tube 12. This is referred to as an interference fit or a press-fit where the end piece 14 is positively retained within the drive shaft tube 12 by the amount of friction between the two work pieces 12 and 14 after they have been pushed together.

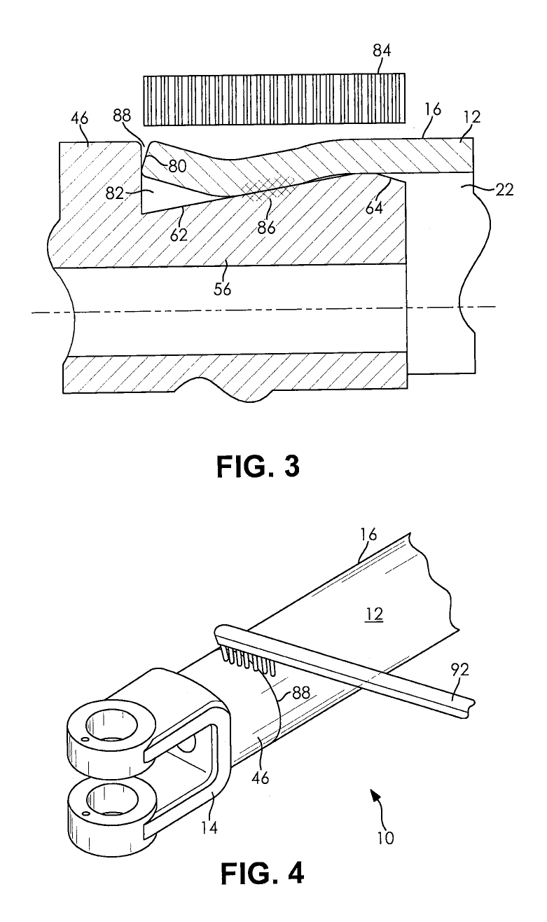

As illustrated in FIG. 3 of the disclosure, once the end piece 14 is assembled within the hollow portion 22 of the first end portion 16 of the drive shaft tube 12, the end piece 14 and the drive shaft tube 12 are placed within a magnetic pulse welding machine. The magnetic pulse welding machine and the magnetic pulse welding process used may be as described in U.S. RE41,101, U.S. Pat. No. 4,129,846 and/or U.S. Pat. No. 5,981,921 which are hereby incorporated by reference herein in their entirety to the extent permitted by law.

The magnetic pulse welding process uses an inductor (not shown) having an inductor coil 84 to generate an immense and momentary electromagnetic field about the first end portion 16 of the drive shaft tube 12. As illustrated in FIG. 3 of the disclosure, the electromagnetic field generated by the inductor coil 84 exerts a very large electromagnetic force onto the outer surface 20 of the first end portion 16 of the drive shaft tube 12. This causes at least a portion of the first end portion 16 of the drive shaft tube 12 to collapse inward at a high velocity toward the neck portion 56 of the end piece 14. The resulting impact of the inner surface 18 of the first end portion 16 of the drive shaft tube 12 with the outer surface 60 of the first tapered portion 62 of the neck portion 56 of the end piece 14 results a weld or molecular bond 86 to occur therebetween. The first tapered portion 62 of the neck portion 56 of the end piece 14 has been found to provide excellent results during the performance of a magnetic pulse welding process. A more detailed explanation of the structure of the neck portion 56 of the end piece 14 can be found in U.S. Pat. No. 5,981,921 (“the '921 patent”). The disclosure of the '921 patent is incorporated herein by reference in its entirety to the extent permitted by law.

The size, shape and location of the weld region 86 will vary depending on a variety of factors, such as but not limited to, the size of the annular gap 82, the size and shape of the inductor coil 84 used in the magnetic pulse welding process, the angle and velocity of the impact between the first end portion 16 of the drive shaft tube 12 and the neck portion 56 of the end piece 14, and the size, shape, and nature of the materials used to form the drive shaft tube 12 and the end piece 14 of the drive shaft end piece assembly 10. It will be appreciated that the weld region 86 is intended to be representative of an exemplary prime welding area that provides the best possible adherence of the drive shaft tube 12 to the end piece 14. It is within the scope of this disclosure, that the drive shaft tube 12 and the end piece 14 of the drive shaft end piece assembly 10 may also be welded together in other areas during the magnetic pulse welding process.

In some instances, after the magnetic pulse welding process is completed, an annular gap 88 remains at the interface between the end surface 80 of the first end portion 16 of the drive shaft tube 12 and the shoulder portion 74 of the end piece 14. The interface between the end surface 80 of the first end portion 16 of the drive shaft tube 12 and the shoulder portion 74 of the end piece 14 may, or may not, be air-tight and/or water-tight. If the interface between the end surface 80 of the first end portion 16 of the drive shaft tube 12 and the shoulder portion 74 of the end piece 14 is not air-tight and/or water-tight, dirt, debris and/or moisture may accumulate in the annular gap 82. Even if the interface between the end surface 80 of the first end portion 16 of the drive shaft tube 12 and the shoulder portion 74 of the end piece 14 is air-tight and/or water-tight, the annular gap 88 is typically large enough to retain dirt, debris and/or moisture.

The build-up of moisture within the annular gaps 82 and/or 88 is particularly problematic as it may lead to corrosion of the end piece 14 and/or the drive shaft tube 12 of the drive shaft end piece assembly 10. For example, if the moisture retained within the annular gaps 82 and/or 88 is composed of salt water, such as that found on winter roads, the salt water can act as an electrolyte between the end piece 14 and the drive shaft tube 12 if they are made of dissimilar materials. Over time, the electrolytic solution may cause an amount of galvanic corrosion to begin between if left untreated. Any corrosion at the annular gap 88 will initially result in a degraded appearance. If the corrosion is not dealt with, it can compromise the weld 86 between the drive shaft tube 12 and the end piece 14 reducing the overall life and durability of the drive shaft assembly 10.

In order to prevent moisture from entering into and/or residing within the annular gaps 82 and/or 88, a coating 90 can be applied to the annular gap 88 thereby sealing the annular gaps 82 and 88 and preventing the ingress of dirt, debris and/or moisture into the annular gaps 82 and 88. The coating 90 provides a corrosion barrier between the environment and the annular gaps 82 and 88.

The process of applying the coating 90 may begin by starting with a cleaning step. According to the embodiment of the disclosure illustrated in FIG. 4 and as a non-limiting example, the cleaning step may include removing any surface dirt, debris, contaminants and/or liquids from the annular gaps 82 and/or 88 by using a wire brush 92 or a rotary wire wheel (not shown). Additionally, the area surrounding the annular gaps 82 and 88 by using the wire brush 92 or the rotary wire wheel (not shown) to remove any surface dirt, debris, contaminants and/or liquids. Many different cleaning steps, in place of or in combination with the wire brush 92 cleaning, may be used depending on the type and amount of material(s) present on, around and/or near the annular gaps 82 and 88.

If the drive shaft tube 12 and the end piece 14 are relatively clean after the magnetic pulse welding process is completed, an amount of alcohol, such as but not limited to isopropyl alcohol, may be used as necessary as a solvent and/or cleaner to remove dirt, debris and/or moisture from the annular gaps 82 and/or 88. The isopropyl alcohol flushes the annular gaps 82 and 88 of any remaining dirt, debris and/or moisture thereby cleaning the surfaces so coating 90 can be applied. Other solvents and/or cleaners may additionally or alternatively be used without going beyond the bounds of the disclosure. The cleaner(s) and/or solvent(s) may be applied by hand using a wipe, such as a towel or towelette, with the cleaner(s) and/or solvent(s) already located therein or manually applied thereon. It is within the scope of this disclosure that the cleaner(s) and/or solvent(s) may also be used before and/or after the annular gaps 82 and 88 are cleaned using the wire brush 92 or rotary wire wheel (not shown) is used.

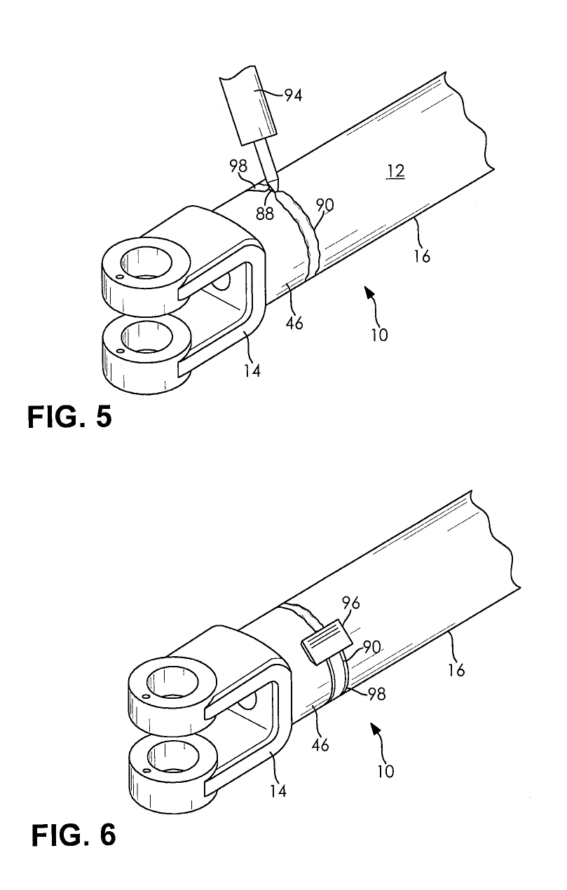

After the annular gaps 82 and/or 88 have been cleaned, the coating 90 is applied. As illustrated in FIG. 5 of the disclosure, the coating 90 is applied using a dispenser 94 over the entire annular gap 82 thereby sealing the annular gaps 82 and 88 from the environment. According to an embodiment of the disclosure and as a non-limiting example, the coating 90 may be an adhesive composition such as an epoxy composition. As a non-limiting example, the coating 90 may be a Loctite H8100 adhesive. In accordance with this embodiment of the disclosure, the user would apply the Loctite H8100 adhesive coating material using a Loctite dual cartridge dispenser that dispenses the Loctite H8100 at a ratio of 10:1. It is within the scope-of this disclosure that other coating compositions 90 that cure quickly, have a high bonding strength, have high elongation properties and/or high cold temperature impact resistance may be used.

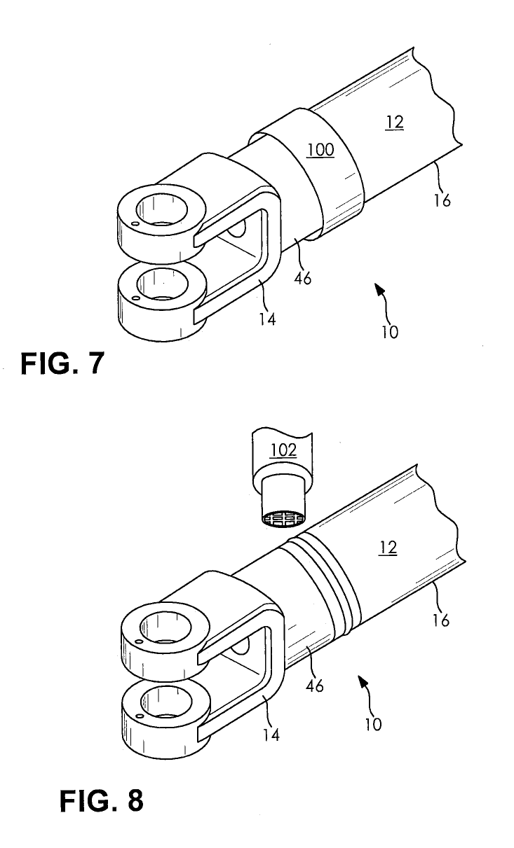

As illustrated in FIG. 6 of the disclosure, as soon as the coating 90 is dispensed from the dispenser 92 and applied within the annular gap 88, a rubber squeegee blade 96 is used to force the coating material 90 further into the annular gap 88. Additionally, the rubber squeegee blade 96 levels the coating material 90 to the surface of the end piece 14 and the drive shaft tube 12 of the drive shaft and end piece assembly 10. When using the rubber squeegee blade 96, it is important to work quickly in order to ensure that the coating material 90 is leveled and forced within the annular gap 88 before the coating material begins to harden. Depending on the type of coating material 90 used, the hardening time will vary, however this step typically needs to be performed within approximately 15 minutes after the coating material 90 is dispensed from the dispenser 94.

According to an alternative embodiment of the disclosure, a sacrificial material 98 may be applied within the annular gap 88 and/or in the area surrounding the annular gap 88 of the drive shaft and end piece assembly 10. The sacrificial material 98 acts like a sacrificial compound promoting galvanic corrosion of the sacrificial material 98 and not at the interface between the end surface 80 of the first end portion 16 of the drive shaft tube 12 and the shoulder portion 74 of the end piece 14. In accordance with an embodiment of the disclosure illustrated in FIG. 7 and as a non-limiting example, the sacrificial material 98 may extend beyond the coating material 90. It is within the scope of this disclosure that the sacrificial material 98 may be applied before and/or after the coating material 90 is applied. As a non-limiting example, the sacrificial material 90 may be a grease based composition, a silicone based composition, a zinc paint and/or zinc paste.

Disposed at least partially radially outboard from the annular gap 88, the coating material 90 and/or the sacrificial material 98 is a shrink-wrap material 100. As illustrated in FIG. 7 of the disclosure and as a non-limiting example, the shrink-wrap material 100 is a substantially cylindrical tube. The shrink-wrap material 100 is a heat shrinkable material that provides an additional seal around the annular gap 88 of the drive shaft and end piece assembly 10 providing further protection against corrosion of the end piece 14 and/or the drive shaft tube 12. As a non-limiting example, the shrink-wrap material 100 is a rugged medium wall tubbing having a 3:1 ration of a polyolefin that is 1.5 inches in length. It is within the scope of this disclosure that any shrink-wrap material having high impact resistance, high abrasion resistance, high ultra-violet light resistance and/or high cold temperature performance.

In accordance with an alternative embodiment of the disclosure (not shown), at least a portion of the sacrificial material 98 extends outside the shrink-wrap material 100.

As illustrated in FIG. 8, once the shrink-wrap material 100 is properly placed radially around the annular gap 88, the coating material 90 and/or the sacrificial material 98 a heat gun 102 is used to shrink the shrink-wrap material 100 and seal is around the annular gap 88, the coating material 90 and/or the sacrificial material 98. It is important to ensure that the shrink-wrap 100 is being heated evenly around the circumference of the drive shaft 12 and the end piece 14 in order to ensure the shrink-wrap material 100 shrinks uniformity.

The coating material 90, the sacrificial material 98 and/or the shrink-wrap material 100 ensures that dirt, debris and/or moisture does not reach the annular gap 88. As a result, the portions of the drive shaft tube 12 and the end piece 14 in the annular gap 88 do not experience corrosion and the weld 86 does not degrade thereby increasing the overall life and durability of the drive shaft and end piece assembly 10.

Although the present disclosure is directed to securing the end piece 14 to an end of the drive shaft tube 12 to form a portion of a drive shaft and end piece assembly 10, it will be appreciated that the apparatus and method of this disclosure can be used with any two or more work pieces that are joined together for any desired purpose or application. It will also be appreciated that the invention can be used simply to fill a gap or void in any structure, whether that gap or void is created at the interface of two or more structures or if the gap or void is located anywhere within a unitary structure.

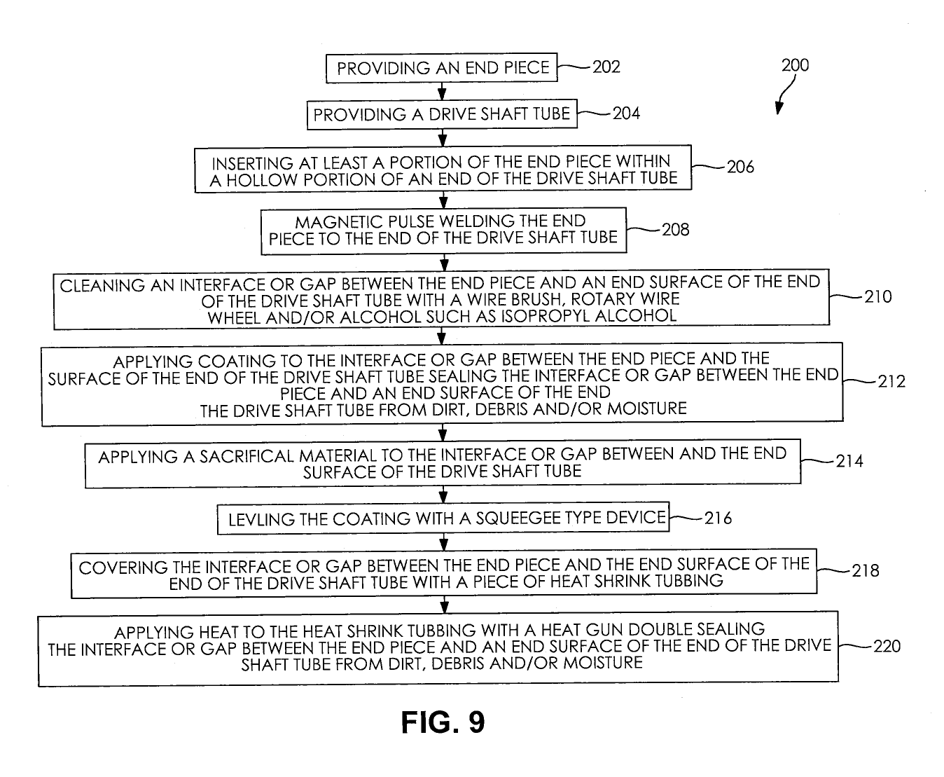

FIG. 9 is a flow chart illustrating an exemplary method 200 of sealing the gap 82 and/or 88 between the end piece 14 and the drive shaft tube 12. The method 200 includes first providing an end piece 202 and providing a drive shaft tube 204. As a non-limiting example, the end piece and the drive shaft tube may be the end piece 14 and the drive shaft tube 12 illustrated in FIGS. 1-8 of the disclosure. Once the end piece 14 and the drive shaft tube 12 have been provided in steps 202 and 204, the step of inserting at least a portion of the end piece within the within a hollow portion of an end of the drive shaft tube 206 is performed. In order to secure the end piece 14 to the drive shaft tube 12, a magnet welding process 208 is used to integrally connect the end piece 14 to the drive shaft 12 of the drive shaft end piece assembly 10.

After the end piece 14 has been integrally connected to at least a portion of the drive shaft tube 12, a cleaning process 210 is performed. The cleaning process 210 is used to clean the interface between the end piece 14 and the end surface 80 of the end of the drive shaft tube 12. As previously discussed and as a non-limiting example, the cleaning process 210 may incorporate the use of the wire brush 92, the rotary wire wheel (not shown) and/or alcohol such as isopropyl alcohol.

Following the cleaning process 210, a coating application process 212 is performed. In the process of applying the coating 212 the coating 90 is applied to the interface between the end piece 14 and the end surface 80 of the end of the drive shaft tube 12 thereby sealing interface from dirt, debris and/or moisture. As previously discussed, the coating 90 provides a corrosion barrier between the environment and the annular gaps 82 and 88 of the drive shaft end piece assembly 10.

In accordance with the method 200 illustrated in FIG. 9 of the disclosure, a sacrificial material application process 214 may also be performed. In the process of applying the sacrificial material 214 the sacrificial material 98 is applied to the interface between the end piece 14 and the end surface 80 of the end of the drive shaft tube 12. As previously discussed, the sacrificial material 98 acts like a sacrificial compound promoting galvanic corrosion of the sacrificial material 98 and not at the interface between the end surface 80 of the drive shaft tube 12 and the shoulder portion 74 of the end piece 14. It is within the scope of this disclosure that the step of applying the sacrificial material 214 may come before the step of applying the coating 212. Additionally, it is within the scope of this disclosure that the step of applying the sacrificial material 214 may not be used at all or may be used instead of the step of applying the coating 212. In accordance with this embodiment of the disclosure, the coating 90 is not used and only the sacrificial material 98 is used to interface between the end piece 14 and the end surface 80 of the end of the drive shaft tube 12 from dirt, debris and/or moisture.

Once the step of applying the coating 212 and/or the step of applying the sacrificial material 214 have been performed, a leveling process 216 is performed. In the leveling process 216, the coating 90 and/or the sacrificial material 98 are leveled using a squeegee type device 96. The leveling process 216 ensures that the coating 90 and/or the sacrificial material 98 completely covers the interface between the end piece 14 and the end surface 80 of the end of the drive shaft tube 12. Additionally, the leveling process 216 is used to force the coating 90 and/or the sacrificial material 98 into the annular gaps 82 and/or 88 thereby ensuring that the coating 90 and/or the sacrificial material 98 have a strong bond with the end piece 14 and the drive shaft tube 12.

After the step of applying the coating 212 and/or the step of applying the sacrificial material 214 have been performed, a covering process 218 is performed. In the covering process 218, the heat shrink tubing 100 is provided and is disposed radially over the interface between the end piece 14 and the end surface 80 of the end of the drive shaft tube 12. Once the heat shrink tubing 100 is in place, a heating process 220 is performed. In the heating process 220, the heat gun 102 is used to apply an amount of heat to the heat shrink tubing 100. The heat shrinks the heat shrink tubing 100 thereby double sealing the interface between the end piece 14 and the end surface 80 of the end of the drive shaft tube 12 from dirt, debris and/or moisture.

In accordance with the provisions of the patent statutes, the present invention has been described to represent what is considered to represent the preferred embodiments. However, it should be note that this invention can be practiced in other ways than those specifically illustrated and described without departing from the spirit or scope of this invention.

What is claimed is:

1. A method of preventing corrosion between work pieces, comprising the steps of:
providing a drive shaft having a first end portion having an inner surface and an outer surface defining a hollow portion therein;
providing an end piece having a first end portion and a second end portion, wherein said first end portion has a first axially extending yoke arm and a second axially extending yoke arm, wherein said second end portion of said end piece has a neck portion having a first tapered portion and a second tapered portion, wherein said end piece is mad of a different material than said drive shaft;
inserting at least a portion of said neck portion of said end piece within said hollow portion in said first end portion of said drive shaft;
magnetic pulse welding said inner surface of said first end portion of said drive shaft to said first tapered portion of said neck portion of said end piece;
applying a coating material over an interface between an end surface of said first end portion of said drive shaft and said end piece defining a gap;
applying a sacrificial material over said gap;
leveling said coating material and said sacrificial material;
aligning a shrink-wrap material radially outboard from said gap; and
applying heat to said shrink-wrap material sealing said gap.
